(19) United States
(12) Patent Application Publication
(10) Pub. No.: US 2006/0121126 A1
(43) Pub. Date: Jun. 8, 2006

(54) Environmentally friendly pesticide and method of use

(76) Inventors: David McFadden, Pacific Grove, CA (US); Ray Sobeck, Monterey, CA (US)

Correspondence Address: Howard M. Peters;PETERS, VERNY, JONES, SCHMITT & ASTON, L.L.P., Suite 230, 425 Sherman Avenue, Palo Alto, CA, 94306, US

(21) Appl. No.: 11/244,472

(22) Filed: Oct. 5, 2005

Related U.S. Application Data
(60) Provisional application No. 60/616,505, filed on Oct. 5, 2004.

(51) Int. Cl. A01N 45/00; A01N 39/00

(52) U.S. Cl. 424/616; 514/26

(57) ABSTRACT

The present invention provides a pesticide formulation that is effective, non-persistent in the environment, and meets the criteria for use in organic food production as set for the by the United States Department of Agriculture (USDA) and Organic Materials Review Institute (OMRI). The formulation may be used for the control and eradication of pathogens such as germs and viruses, insects, insect larvae, mold, slime and fungus, and algae. The compositions provide a formulation containing an oxidizing compound in conjunction with a botanically derived surfactant/membrane permeablization agent. The formulation typically contains a hydrogen peroxide generating compound(s) and saponin glycoside compounds, which, in combination, show enhanced activity towards insects, pathogens algae, slime, mold and fungus. The method is exemplified by applying an effective amount of a composition containing an aqueous mixture of hydrogen peroxide and surface-active saponin botanical extracts preferentially derived from Quillaja saponaria and/or Yucca schidigera, to water bodies, surfaces, and in or on turf. The composition is also effective for control of odors and sulfurous black layer found in turf.

### RELATED APPLICATIONS

This application is a continuation-in part-of U.S. Ser. No. 60/616,505, filed Oct. 5, 2004, which is incorporated herein by reference in its entirety.

### BACKGROUND

1. Field of Invention

The present invention provides a pesticide formulation that is effective, non-persistent in the environment, and meets the criteria for use in organic food production as set for the by the United States Department of Agriculture (USDA) and Organic Materials Review Institute (OMRI). The formulation may be used for the control and eradication of pathogens such as germs and viruses, insects, insect larvae, mold, slime and fungus, and algae. The compositions provide a formulation containing an oxidizing compound in conjunction with a botanically derived surfactant/membrane permeablization agent. The formulation normally comprises at least one hydrogen peroxide generating compound and at least one saponin glycoside compound, which, in combination, show enhanced pesticide activity toward insects, pathogens algae, slime, mold, fungus, and the like. The method is exemplified by applying an effective amount of a composition as an aqueous mixture of hydrogen peroxide and surface-active saponin botanical extracts preferentially derived from Quillaja saponaria and/or Yucca schidigera, to water bodies, surfaces, and in or on turf. The composition is also effective for control of odors and sulfurous black layer often found in turf.

2. Discussion of Related Art

Pesticides are commonly used in a multitude of settings, from homes, schools, and offices to manufacturing plants, cargo containers, and agricultural contexts. Most pesticides are generally insect or arachnid nervous system toxicants, inhibiting or overpotentiating synapse-synapse and/or neuro-muscular junction transmission, many acting specifically as acetylcholinesterase inhibitors.

Most of these compounds are synthetic organic chemicals which may have a broad spectrum of toxicity and are persistent in the environment. Representative examples of conventional pesticides include: 1) chlorinated phenyl and cyclodiene compounds such as DDT, chlordane, heptachlor, and aldrin and dieldrin; 2) the carbamate esters carbaryl, carbofuran, aldicarb, and baygon; 3) organic thiophosphate esters such as diazinon, malathion, parathion, and dicapthon; and 4) the synthetic pyrethroids allethrin, permethrin, resmethrin, and fenvalerate. Worldwide, millions of kilograms of pesticides are applied to land and water to control and eradicate disease causing pathogens, insects, and for the control of algae. Botanically derived compounds such as pyrethrins have found favor, due to selectivity, decreased toxicity, and ease of production. However, insects, including mosquitos are now increasingly displaying resistance to pyrethrin compounds and their derivatives. Worldwide, mosquito control is an extremely important issue, because mosquitos are vectors for dehabilitating diseases such as dengue fever (Aedes aegypti), and more recently, West Nile virus (Culex pipiens). Malaria in particular, still causes untold suffering and loss of human productivity worldwide. Mosquito control is typically achieved by manual and aerial spraying of parathion insecticide, which has significant toxicity concerns, as well as DDT, an environmentally persistent agent that still finds use in the 3^{rd} world and under emergency situations.

These and other pesticides present risks to human health. Although the rate of post-application degradation may vary widely, almost all pesticides present some direct risk to human health through residual toxicity, i.e. direct human contact with pesticide residues remaining after treatment, whether through inhalation of volatile toxic vapors, skin contact and transdermal absorption, or ingestion. In addition, many pesticides present indirect risks to human health in the form of environmental pollution, most notably pollution with persistent, halide-substituted organics, which accumulate in the fat stores of food fish, as well as other animals up the food chain. These problems have led to complete bans on the use of some pesticides—e.g., DDT, chlordane, heptachlor, aldrin, and dieldrin—while the continued use of the remaining pesticides has produced a new problem: the increasing development of widespread resistance to pesticides.

Another example that illustrates the need for a more effective and environmentally friendly pesticide involves rice production, which utilizes many thousands of acres containing standing water. These areas produce algal blooms and associated mosquito infestations. Insecticides and algaecides used in the rice industry have toxicity and persistence issues associated with them. Thus, there is a need for a biodegradable and environmentally friendly pesticide in food production areas where mosquitos may thrive, as well as an algaecide that does not contain toxic copper.

Another area of concern is nematode worms in crop production. Nematodes have raised great economic and humanitarian concern due to their impact on the world's agricultural output as well as their impact on human and animal suffering and disease. Regarding the impact nematodes have on agriculture, annual worldwide losses resulting from nematode infestation have been estimated to be about $78 billion. In the United States alone, annual losses due to nematode-related crop diseases are estimated to be about $8 billion. The impact on a crop production by a single nematode-related pathogen can be severe. For example, the soybean cyst nematode causes annual losses of about $267 million in the north central United States; $38 million in state of Missouri alone.

Tomatoes and strawberry production are often the agronomic crops most severely impacted by nematode infestation. Control of nematode infestation of these crops historically has depended on low cost, highly effective chemicals including methyl bromide (CH₃Br), ethylene dibromide (C₂H₄Br₂, “EDB”), and 1,2-dibromo-3-chloropropane (C₃H₅Br₂Cl, “DBCP”). However, the application of these workhorse pesticides has been or will soon be banned by governmental regulatory agencies because of their unwanted health and environmental impacts. The resulting economic impacts from these impending bans will be severe.

Unfortunately, no truly viable successor to methyl bromide, EDB, or DBCP has yet been found. The pesticides sold commercially under the trade names TEMIK and DAZOMET have limited registration. Other commercially available pesticides, such as those sold under the trade names CARBOFURAN, VAPAM, and CHLOROPICRIN, have limited effectiveness. Still other nematicides have been shown to be carcinogenic (e.g., the pesticide sold as TELONE). Recently the pesticides sold under the names ALDICARB and CARBOFURAN have lost registration. Development of new chemicals having effective nematicidal applications in the near future appears remote; in fact, no new nematicide has been developed since 1974. For example, phytoparasitic nematode worms that infest crops require fumigation by toxic materials such as dithiocarbamates. Nematodes are responsible for billions of dollars of losses in crop production, and are thus a primary target for eradication by traditional pesticides. Nematode worms are also parasitic to turf grass and the like, and represent a growing problem to industries dependant on turf grass and other plants susceptible to root infestation.

Another area of concern involves the fouling of waters by algae, which also serves as a nursery or breeding ground for insect pests and pathogens. Filamentous algae and primitive blue-green algaes are examples of plant pests which are responsible for the fouling of waterways used for navigation, to hold wastewaters from agriculture and municipalities, and or as a source of drinking water. Water features including ponds, fountains, waterfalls, pools, and reservoirs suffer also suffer from algal growth, such as string algae, that is promoted by sunlight, warm water, decomposition of organic matter, and the effluent from the biological processes of animals and invertebrates. Oxygen depletion, a result of mass algae respiration, yields a reducing anaerobic environment that may result in the die-off of flora and fauna that depend on oxygen, growth of harmful pathogens and fungi, and create noxious odors derived from amines and sulfides. These conditions promote further algae growth that ultimately kills off a pond entirely and impedes mechanical and hydraulic processes by clogging and other means.

The following U.S. Patents are of interest in this area:
1. U.S. Pat. No. 6,750,256, Jun. 15, 2004, Crandall, Jr.; B. G. et al.
2. U.S. Pat. No. 6,743,752 Jun. 1, 2004 Dutcheshen.
3. U.S. Pat. No. 5,698,191, Dec. 16, 1997, Wiersma; C. et al.
4. U.S. Pat. No. 6,455,075 Sep. 24, 2002, Larose.
5. U.S. Pat. No. 6,251,951 Jun. 26, 2001, Emerson, et al.
6. U.S. Pat. No. 6,197,784 Mar. 6, 2001 Fuchs, et al.
7. U.S. Pat. No. 5,639,794 Jun. 17, 1997, Emerson, et al.
8. U.S. Pat. No. 5,256,423 Oct. 26, 1993 Egusa, et al.

The following references describe the antimicrobial and pest activity of a saponin isolated from fruit pulp, tobacco, and seed:
9. Okunji et al., Int. J. Crude Drug Res., (1990), 28(3), (193-199).
10. Gruenweller et al., Phytochemistry (Oxf), (1990), 29(8), (2485-2490).
11. Lalithat et al., Int. Pest Control, (1988), 30(2), (42-45).
12. Pelah et al., Journal of Ethnopharmacology, (2002), 81, (407-409).
13. Chitwood, D. Annu. Rev. Phytopathol., (2002), 40, (221-249).

The following references describe hydrogen peroxide for algae and pathogen control:
14. Barrion, G. et al., Wat. Res. (1986), 20:5, (619-623).
15. Baldry, M. G. C., Journal of Applied Bacteriology, (1983), 54, (417-423).
16. Ouzts, J. D., Mosquito News, (1981), 6, (375-376).

All U.S. patents, U.S. patent applications and articles cited herein are incorporated by reference in their entirety.

### SUMMARY OF THE INVENTION

The present invention concerns a novel pesticide formulation, which comprises an oxidizing component in combination with an environmentally friendly carrier. More preferably the composition comprises hydrogen peroxide and/or a hydrogen peroxide generating component and a botanically derived surfactant membrane permeablization agent, such as a saponin glycoside. This combination shows surprising enhanced activity in the control and removal of insects, pathogens, algae, slime, mold, fungus, odor, and the like. The methods of application and the methods of control of these pests are also claimed.

In another embodiment the present invention concerns a pesticide a composition and an environmentally friendly method for the control of pests, such as a pesticide composition for controlling stench, algae, moss, slime, mold, fungus, insects, insect larvae, pathological organisms, anaerobic conditions and combinations thereof in water bodies, on plants, in soil, on surfaces and combinations thereof, said composition comprising: an oxidizing component selected from the group consisting of hydrogen peroxide, a hydrogen peroxide-generating chemical compound, an inorganic hydroperoxide, an organic peroxy acid and combinations thereof and a saponin glycoside.

### BRIEF DESCRIPTION OF THE FIGURES

The present invention is further described in the following figures:

FIG. 1 is a graphic representation of the effect of added saponin on the amount of the dose of hydrogen peroxide required to achieve 50% mortality of mosquito larvae in 24 hours.

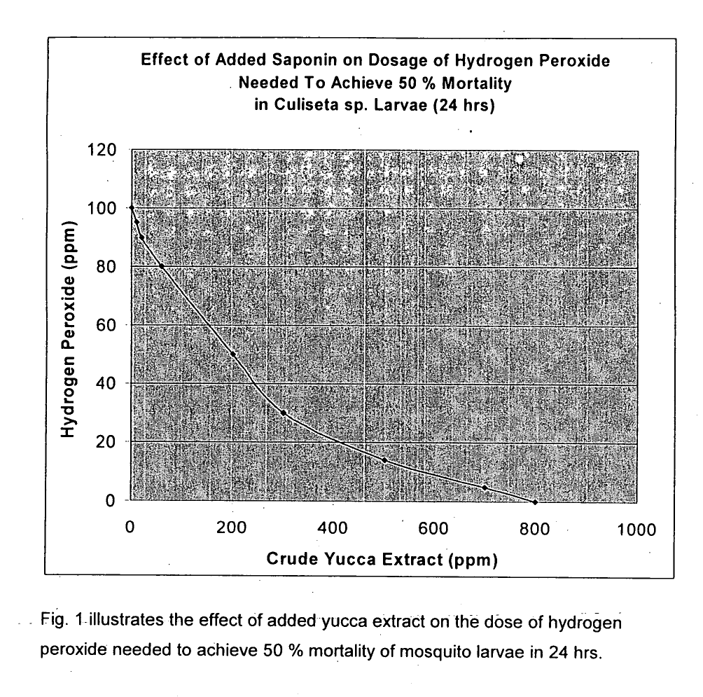

FIG. 2 is a schematic representation of the nematode mortality response of hydrogen peroxide saponin composition versus hydrogen peroxide contact alone.

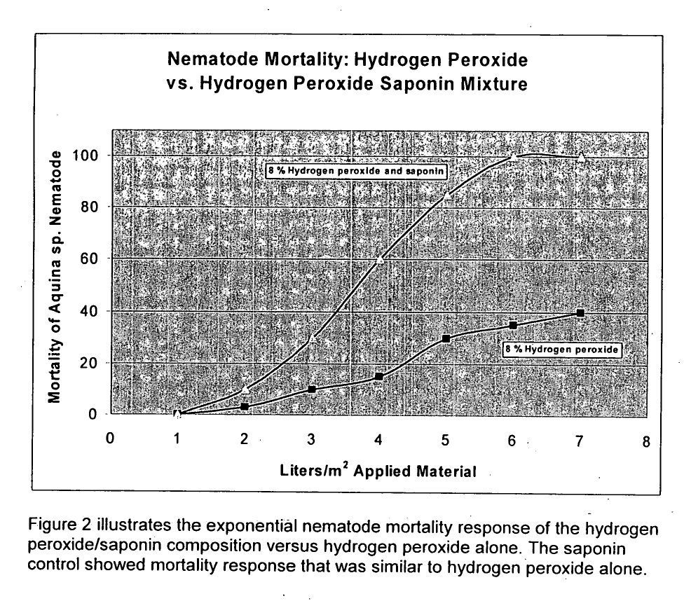

FIG. 3 is a schematic representation of the chemical structure of a saponin glycoside.

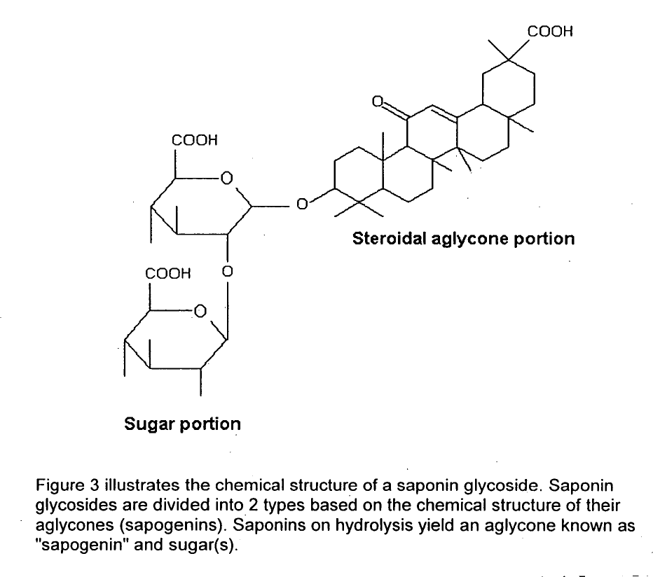

### DETAILED DESCRIPTION OF THE INVENTION AND PREFERED EMBODIMENTS

Definitions

The terms, names and descriptions herein are given the ordinary and common usage in this art. See for example, Hawley's Condensed Chemical Dictionary, Fourteenth Edition, published periodically and/or the Kirk-Othmer Encyclopedia of Chemical Technology, Fourth Edition, both published by John Wiley and Sons.

As specifically described herein

Definitions

As described herein

“Formulation” refers to an aqueous mixture containing an amount of inorganic peroxide chemical, saponin glycoside surfactant/wetting agent, with or without organic acids.

“Application methods” refers to the mode by which the composition or formulation is applied to a surface, a water body, to plants, to soil or in soil.

“Hydrogen peroxide generator” refers to an inorganic chemical compound that produces hydrogen peroxide or hydroxyl radical when dissolved in water. The percentages reported herein refer to the weight % of the equivalent hydrogen peroxide generated.

“Saponin glycoside surfactant” refers to an organic chemical compound containing a steroid functionality or a terpenenoid fragment, combined with a sugar moiety or multiple sugar moieties.

This art describes the use of a variety of chemical compositions and techniques for the control and eradication of algae in waterways, ponds, reservoirs, and lakes, including the application of bleach, bacteria, enzymes, synthetic organic polymers, synthetic organic small molecules, and copper sulfate, mostly to the entire water body. Typically, the aforementioned materials are used by direct addition to said water body by in-line flow injection or by dumping volumes of the material into the water body proper.

The conventional methods do not selectively treat portions of the water body nor do these methods selectively treat functional or ornamental features that make up the entire water feature or system. The present invention provides a composition and a method to overcome the deficiencies in the art.

An environmentally friendly pesticide composition and a method of use and application are provided. The formulation is non-persistent in the environment, and meets the criteria for use in organic food production as set for the by the United States Department of Agriculture (USDA) and Organic Materials Review Institute (OMRI). The chemical composition is biodegradable, relatively non-toxic to non-target flora or fauna, and is effective in the control and eradication of surface and waterborne insect larvae, algae, mold, fungus, slime and the like. The composition is also useful for spraying on crops and in or on turf to control nematode worm infestations in turf and on food crops.

The unique formulation also achieves rapid destruction of algae and subsequent flotation of algae for easy removal by skimming. Method of application involves injection into the water body or turf, manually or by machine, and/or by manual or mechanical spraying or misting. Uniquely, the present composition may be applied using selective spray application to the water body or features therein without the need for treating the entire water body with the composition. This is generally effective and is more efficient under many circumstances, especially in the treatment or ornamental water bodies such as ponds, or waterfalls. The practice of selective application also protects desirable flora and fauna in the water body.

The preferred composition contains hydrogen peroxide or a hydrogen peroxide generator compound and botanical saponin glycoside surfactant, with or without pH modifying acids or stabilizers. The aqueous mixture of these materials provides an oxidizing mixture and a surfactant, that in combination provides an effective pesticidal formulation, that displays increased pesticidal activity over hydrogen peroxide alone, or saponin extract, alone.

Saponin Component

The saponin surfactant provides multiple benefits including surface coating, membrane permeablization, and its own larvicidal and anti-microbial properties. The multi-role saponin surfactant also increases the efficacy of the peroxide oxidizer by increasing the susceptibility of the organism or plant to the oxidative action of the hydrogen peroxide. In this practice, less hydrogen peroxide is needed for the effective oxidation or destruction of the target.

The saponin ingredient of the composition of this invention is any one or more of the natural saponins, which are foam producing water-soluble glycosides found widespread in the plant kingdom. Structurally, saponins are characterized by one or more carbohydrate moieties linked to a polycyclic aglycone or sapogenin moiety, which can have asteroid, triterpene, or steroid alkaloid ring system. The carbohydrate moieties are most frequently derived from glucose, but saponins in which the aglycone is linked to other saccharides including without limitation rhamnose, xylose, galactose, and mannose, as well as disaccharides and trisaccharides, are also useful. Saponins are usually found in complex mixtures of closely related compounds, but separation of individual saponin compounds from one another is not required for use in accordance with this invention.

The saponins for use in the present invention are produced and/or isolated from various plant parts including fruit, leaf, seed and/or root, using means known in the art, from a variety of sources including the various plants known to produce them, ranging from yucca, quillaja, agave, tobacco, licorice, soybean, ginseng and asparagus to aloe woods. Saponins for use in the present invention are preferably non-toxic to humans and higher mammals, vertebrates?

Most preferably the saponin for use in the present invention is non-toxic food grade, the source being from yucca plants with the most preferred being derived from Yucca schidigera or Y. valida and their equivalents. Saponins from Yucca schidigera contain steroidal saponins with the major sapogenins being sarsapogenin and tigogenin. The sarsaponin yields on hydrolysis, sarsasapogenim (sarsasapogenim 5-beta, 20-betaF, 22-deltaF, 25-betaF; also known as spirostan-3-beta-01 and parigenin), glucose and galactose. The sarasapogenim has a molecular formula of C₂₇H₄₄O₃. Nobel, Park S., Agaves, Oxford Univ. Press, New York, 1994. Accordingly, derivatives of these compounds, which produce a formulation having the desired pest growth controlling properties, are considered equivalents of the invention. Saponins have diverse activities, which are attributable to the chemical make-up of a particular saponin and most typically are dependent on the source from which the saponin is derived. For example, saponins derived from Japanese Camilla control the growth of mosquito larvae. Saponins from sources other than Yucca plants can be used as active agents in insecticidal compositions. As appropriate, it is preferable to select a saponin that increases the pest growth controlling effect of a formulation as compared to a formulation that excludes the saponin.

It is noteworthy that the bark of Q. saponaria is another major source of industrial triterpenoid saponins and may be used in this invention. Quillaja saponaria is a large evergreen tree with shiny, leathery leaves and a thick bark native to China, Peru, and the arid zones of Chile. Its bark has been found to be rich in saponins, plant glycosides, which are widely distributed in the plant and marine and animal kingdoms. Saponins have diverse activities, which are attributable to the chemical make-up of a particular saponin and most typically are dependent on the source from which the saponin is derived. Again, as appropriate, it is preferable to select a saponin that increases the pest growth controlling effect of a formulation as compared to a formulation that excludes the saponin.

Hydrogen Peroxide Oxidizer Component

Aqueous hydrogen peroxide is the preferred oxidant in the composition because of its reasonable cost, ease of handling, oxidizing potential, low toxicity, and desirable non-toxic decomposition byproducts, water and oxygen. This is a distinct advantage over other oxidizers such as sodium hypochlorite, or bleach, which may produce unwanted and toxic chlorinated hydrocarbons, and is potentially toxic to flora and fauna at low concentrations. In contrast, hydrogen peroxide decomposes to water and oxygen, and is an approved pesticide for use in organic production, as set forth by the USDA and OMRI. The mode of action of the oxidizing radicals formed by hydrogen peroxide is shown below:

### Equation 1: Generation of Oxidizing Hydroxyl Radicals

2H₂ [symbol] 4HO.

### Equation 2: Decomposition of Hydroxyl Radicals after Oxidation of Matter

4 HO. [symbol] O₂+2H₂O

### Equation 3: Net Equation or the Sum of Equations 1 and 2

2H₂O₂ [symbol] O₂+2H₂O

It is noteworthy that any compound providing hydrogen peroxide may be used in the invention. This includes solid sodium percarbonate (Na₂CO₃.3H₂O₂), which dissolves in water to provide active hydrogen peroxide, and an alkaline solution. Generation of hydrogen peroxide with sodium percarbonate may be desirable in those water systems with low pH values. Other alternative peroxide sources include: sodium peroxide, sodium perborate, and sodium persulfate, calcium peroxide, and magnesium peroxide. The various hydrates and alternate metal salts of the inorganic peroxides are also suitable. Percarboxylic acids in this invention may be chosen from mono, di, tri, or polyprotic percarboxylic acids and are thus selected from a group including but not restricted to: performic acid, peracetic acid, perpropionic acid, mono- and diperoxysuccinic acid, mono- and diperoxyglutaric acid, peroxylactic acid, peroxyglycolic acid and peroxytartaric acid. Peracetic acid, performic acid and solutions containing peracetic acid and performic acid are preferred. The percarboxylic acid may be generated in situ, by the combination of hydrogen peroxide, the organic acid and a suitable catalyst, or may be preformed prior to mixing and application. The generation of percarboxylic acids is well known to those of ordinary skill in this art.

Stabilizing Acids

Mono, di, tri, or poly protic inorganic and organic acids may be used in the formulation as pH modifiers, buffers, or stabilizing agents. Organic carboxylic acids are preferentially used in the formulation as pH modifiers, buffers, or stabilizing agents. In particular, acids that meet the criteria for use in organic production as set forth by OMRI and USDA are preferred in this invention. Examples of such acids include citric acid and ascorbic acid (vitamin C). These acids are easily metabolized and neutralized by flora and fauna in nature, and thus are worthwhile choice an environmentally friendly pesticide formulation. It is noteworthy that organic carboxylic acids are also useful in chelating transition metals, which may lead to premature decomposition of the hydrogen peroxide, the oxidizing component of the formulation.

The citric acid stabilizer concentration ranges from about 0.1 to 30% by weight, preferably between about 0.5 and 25% by weight, and more preferably between about 1 and 20% by weight in the mixture, and provides an acidic medium (pH<<7) so that the hydrogen peroxide does not decompose prior to application. Hydrogen peroxide decomposition significantly increases at pH values greater than 6. It is noted that the mixture must also be free of transition metal ions that catalyze the decomposition of hydrogen peroxide, such as Cu²⁺, Fe²⁺, Fe³⁺, Ti²⁺, etc. Citric acid provides the benefit of metal ion removal by chelation. Citric acid is preferred due to cost, non-toxic nature, metal chelation, and buffering capacity. Citric acid is a triprotic acid that provides three equivalents of protons. The three pKa values are: 3.06, 4.74, and 5.40. Judicious choice of the stabilizing acid will yield a solution that not only stabilizes the peroxide, but also provides acid for neutralizing basic water conditions, as well as buffering capacity, or the ability to maintain desired pH levels within a certain range. Other acid choices include tartaric and ascorbic, both relatively non-toxic and naturally occurring substances.

It is noted that other organic acids may be used, based on pKa values, pH buffering capacity and toxicity. We have found that an acidic solution is preferred in those water features that predominantly display alkaline pH. It is also noted that organic acids are preferred, but inorganic acids may be used as well. However, some inorganic acids may add phosphorous, nitrogen or ionic species that may not be desirable for the optimal water feature ecology.

Formulations: Composition Range, Packaging and Mixing

The preferred formulation contains aqueous hydrogen peroxide in the range of about 3% to 50% by weight, preferably about 4 and 30% by weight, and more preferably between about 5 and 20% by weight, and crude saponin glycoside extract in a concentration ranging from about 0.0001% to 25% by weight, preferably between about 0.01 and 20% by weight, and more preferably between about 1 and 5% by weight. Organic acids such as citric and ascorbic are provided in a range of 0.0001% to 25% by weight, preferably between about 0.01 and 10% by weight, and more preferably between about 0.1 and 5% by weight. Many of these concentrations can be varied depending on the application. It is noted that the compounds are homogeneously mixed in water to afford application.

It is preferred, but not necessary, to provide the composition in the form of a 2-pack formulation, in which the aqueous hydrogen peroxide is in one container, and the saponin glycoside extract with or without organic acid(s) in another. This advantageously allows the user to vary the ratios of the oxidizer to the wetting agent (saponin), depending on the application.

Alternatively, the formulation can be provided premixed, with the proper precautions to prevent premature decomposition of the hydrogen peroxide. It is noteworthy that hydrogen peroxide is most stable under acidic conditions, and in solutions that are free of transition metals that catalyze its decomposition. Therefore, it is preferred that the hydrogen peroxide is stabilized in a transition metal free aqueous solution (deionized or distilled water) metal free organic acid or an inorganic material such as sodium thiosulfate, or other suitable materials. After mixing, the combined composition can be further diluted with water at the site of use. This allows the overall concentration of the mixture to be tailored to the application, which may involve manual or mechanical spray application.

The Method(s) of Application of the Formulation

The preferred method of application is by a spray or stream application of the composition. The mixture can be prepared before application or commixed during the active spray treatment. An example of manual application involves the use of a manual pump sprayer device that has a liquid reservoir, pump handle, and applicator wand with adjustable spray tip. Application of the mixture is not restricted to a manual application. The mixture is also applied by automated mechanical equipment under human or robotic control. Spray booms on land or attached to a helicopter or airplane may be used to broadcast the mixture over large areas such as reservoirs, waste ponds, and lakes.

For small water features, or complex surface areas, manual application is used for selective treatment of structural and ornamental features such as the edges of the water feature, rocks, bridges, abutments, pipes, pumps, and islands. In this fashion, local peak concentrations of the oxidizing mixture are maintained for short periods, and the entire ecosystem or body of water is not subjected to high levels of hydrogen peroxide.

The invention uniquely provides an enhanced method of removal of detritus and debris from a water body after application. Application of the composition increases the buoyancy of scum, detritus, algae, and other organic matter, thus aiding it's removal by mechanical or manual skimming. The increased buoyancy of these materials is a result of the formation of gaseous and dissolved oxygen, a decomposition product of hydrogen peroxide. The micro and macroscopic oxygen bubbles attach to the organic matter in a fashion so that it floats and thus forms an easily removable surface layer. Removal of scum and debris is then achieved by skimming with a net or by the use of a mechanical skimming device well known to those skilled in the art. This combination of methods claimed herein is not described in the literature and provides a significant advantage to our invention.

### EXAMPLES AND ALTERNATIVE EMBODIMENTS

The following examples are provided to be descriptive and illustrative only. They are not to be construed to be limiting in any way.

General

The reagents, chemicals, materials and solvents described are used as received from commercial suppliers unless otherwise noted. (See for example Chem Sources—USA, which is published annually.)

All percentage volumes are by weight. Hydrogen peroxide was conventional.

The organic acids, e.g. citric, ascorbic, etc. were conventional.

The saponin used was conventional and is available from sources such as Desert King International, 7024 Manya Circle, San Diego, Calif., 92154 and Agroindustrias El Alamo, S.A. de C.V., P.O. Box 530324, San Diego, Calif., 95123-0324

### Example 1

### Control of Algae in a Golf Course Water Hazard

A golf course water hazard in Northern California contained a choking growth of string algae during the summer months. These growths were mostly confined to the edges of the water body. Previous methods used to destroy the algae included treatment with toxic copper sulfate, which resulted in the mortality of all flora and fauna in the water feature. Specifically, the waters and pond banks immediately surrounding the algal mat were selectively treated with an aqueous solution of 35% hydrogen peroxide containing 10% citric acid stabilizer, and 0.01% Yucca extract (saponin). After approximately one-half hour, the bulk of the algal mat turned white and broke loose by the oxidative action of the hydrogen peroxide, and was made buoyant by the attached oxygen byproduct thus formed. Other portions of the algal mat disintegrated and thus dispersed. These portions were not skimmed.

### Example 2

### Control of Parasitic Nematode Worms in Turf at a Golf Course by Manual Spraying

A 300-acre golf course in Northern California contained Poa annua turf that suffered form an infestation of the root gall nematode Aquina pacificae. The infestation was manifested by dying and browning golf greens. Inspection of turf roots and galls revealed the presence of the nematode parasitic worm. Subsequent treatment by manual spraying of 1 acre test plots with an aqueous mixture of 8% hydrogen peroxide, 0.1% Yucca extract (20% active saponins, Yucca schidigera), and 2% citric acid resulted in the eradication of the gall nematodes. Approximately 5-10 gallons of the composition was broadcast/acre. Comparison to control plots containing the individual components at the applied volumes and concentrations revealed only small changes in the nematode populations.

### Example 3

### Control of Parasitic Nematode Worms in Turf at a Golf Course by Manual Spraying and Use of a Different Source of Saponin Compound

An almost identical experiment as exemplified in Example 2 is conducted, but with a different saponin extract. Treatment of golf greens infested by nematodes by manual spraying of 1 acre test plots is achieved using an aqueous mixture of 8% hydrogen peroxide, 0.1% Quillaja saponaria extract (saponin), and 2% citric acid. The result is the eradication of the gall nematodes. Approximately 5-10 gallons of the composition are broadcast/acre. Comparison to control plots containing the individual components at the applied volumes and concentrations reveal only small changes in the nematode populations.

### Example 4

### Control of Parasitic Nematode Worms in Turf at a Golf Course by Mechanical Injection of Composition into Turf

A 300-acre golf course in Northern California contained Poa annua turf that suffered form an infestation of the root gall nematode Aquina pacificae. The infestation was manifested by browning golf greens. Inspection of turf roots and galls revealed the presence of the nematode parasitic worm. Subsequent treatment of 100 acres of golf greens by mechanical turf injection with an aqueous mixture of 8% hydrogen peroxide, 0.1% Yucca extract (20% active saponins), and 2% citric acid resulted in the eradication of the gall nematodes. Approximately 5-10 gallons of the composition was broadcast/acre. Untreated areas in the gold course remained infested with nematodes.

### Example 5

### Treatment of Agricultural Wastewaters

Order of addition of the chemical mixture and its components can be varied depending on the pond water quality and conditions. In an alternative embodiment, a 100,000 gallon reservoir containing agricultural wastewaters, choked with algae, and displaying a pH of 8.5 is pretreated with sulfuric acid to a pH of 7 before application of an aqueous mixture containing 10% hydrogen peroxide, 0.1% Yucca extract (20% active saponins), and 2% citric acid. In this case, the pH was deemed too high for effective treatment because the peroxide mixture is rapidly decomposed at pH values exceeding 8. Therefore, in some cases prior pH adjustment might be advantageous before application of the oxidizing mixture. Twenty-four hours after treatment, the bulk of the algae mats are dissipated, and an infestation of black flies is greatly reduced. The formulation is applied by aerial spraying by helicopter.

### Example 6

### Method and Treatment of Algae in a Drained Pond

In an alternative embodiment, a badly fouled pond containing string algae and bacterial slime was drained. The damp watercourses and equipment were then treated with 10% hydrogen peroxide stabilized with citric acid 2% by weight and containing 0.05% yucca (saponin) extract spreading agent by manual spraying of the aqueous mixture. After 24 hrs, the pond and watercourses were refilled with fresh water, and the rocks were hosed with a stream of water to speed the removal of the oxygen swelled filamentous algae. Upon filling, a buoyant surface scum formed that was supported by oxygen bubbles. The scum was comprised of dead algae and other detritus. Subsequently, this surface layer was skimmed manually by nets. The result was a debris- and algae-free aquatic system, with high clarity, that immediately was able to support one dozen large Koi fish without any ill effects. Upon running of the pumps and the waterfalls, more floating algae debris appeared. This material debris was also skimmed and thus removed by the pond systems built-in automatic skimmer.

### Example 7

### Method and Composition for Algae Removal in and on a Fountain

In an alternative embodiment, a granite boulder fountain in Carmel, Calif. is covered by filamentous algae. The water is turned off, and the boulder is directly treated with 7% hydrogen peroxide stabilized with citric acid 2% by weight and containing yucca (saponin) sticking agent 0.02% by weight. A manual pump sprayer was used in the application. After 1 hour, oxygen bubbles swelled and lifted large portions of the algal mat. The water pump was then restarted and large portions of the algal mat were sloughed off. The decomposed mat was then manually removed from the bottom of the fountain boulder.

### Example 8

### Method and Composition for Treatment of Algae in a Pondless Waterfall

In an alternative embodiment, an algae fouled pondless waterfall containing watercourses and a 500 gallon collection basin was turned off and treated with a spray application consisting of 1 gallon mixture of 7% hydrogen peroxide stabilized with citric acid, 2% by weight, saponin spreading/sticking agent, 0.25% by weight. The mixture was uniformly broadcast over the waterfall surfaces and rocks. After 1 hour, the waterfall was turned back on, and the algae, slime, and scum were sloughed off by the action of the waterfall. The buoyant algal mat and associated detritus were collected in the basin at the foot of the waterfall and was subsequently removed by skimming.

### Example 9

### Composition for Control of Mosquito Larvae

A series of control experiments are conducted to study the effect of aqueous hydrogen peroxide and saponin extract on mosquito larvae, individually, and in combination. In a series of 30 experiments, 20 Culex pipiens and Aedes Egypti in the late 3^{rd} instar larvae are placed in a cup containing 150 mL of tap water. In separate experiments, the larvae are exposed to varying concentrations of hydrogen peroxide saponin extract. The mortality is recorded over a 5-day period. It is found that >100 ppm of hydrogen peroxide is need to achieve 50% larvae mortality in 24 hrs, and that >300 ppm of saponin extract from quillaja bark is needed to achieve the same effect. Subsequent experimentation reveals that a combination of hydrogen peroxide and quillaja bark extract is greater than 50% more effective than each individual component alone.

### Example 10

### Method and Composition for Control of Mosquito Larvae Found in Agricultural Crop Waters

In a rice growing region of Northern California, 200,000 acres of rice fields contain large masses of algae and mosquito larvae (Culex pipiens), the bulk of which occur at the edges of the water flooded fields. A 2,000 gallon tanker truck containing a mixture of 5% hydrogen peroxide, 1% saponin extract, and 1% citric acid is driven along the dikes that bisect the rice fields. Spray booms attached to the sides of the truck broadcast the mixture at an application rate of 0.5 gallon/meter². Within 15 minutes the algae is destroyed and dispersed. In 24 hrs the mosquito larvae levels are reduced by one-half and in 48 hrs, by 90%.

### Example 11

### Method and Composition for Control of Odors and Anerobic Conditions Found in Dewatered Sewage Sludge

Twenty acres of odorous and sulfide rich sewage sludge containing 20% water are spray treated with a composition containing 10% hydrogen peroxide, 0.001% yucca extract, and 1% citric acid. The composition is broadcast using spray booms that are arrayed throughout the area. Approximately 0.50 gallon/ft² is applied. After 24 hrs, the stench is non-detectable, and a population of back flies and other vermin are eradicated.

### Example 12

### Control of Parasitic Nematode Worms in Turf at a Golf Course by Manual Spraying

(a) A 300-acre golf course in Northern California contained Poa annua turf that suffered form an infestation of the root gall nematode Aquina pacificae. The infestation was manifested by dying and browning golf greens. Inspection of turf roots and galls revealed the presence of the nematode parasitic worm. General treatment at different concentrations were performed by manual spraying of 1-acre test plots with an aqueous mixture of hydrogen peroxide between about 5 to 17% by weight, 0.2 to 0.5% by weight Yucca extract (20% active saponins, Yucca schidigera), and 1 to 3% by weight citric acid resulted in the eradication of the gall nematodes. Approximately 5-10 gallons of the composition was broadcast/acre. Comparison to control plots containing the individual components at the applied volumes and concentrations revealed only small changes in the nematode populations.

(b) Similarly, when Example 12(a) is repeated using 5% by weight of hydrogen peroxide, 0.2% by weight of saponin and 2% by weight of citric acid, the results are equivalent to those observed in Example 12 (a).

(c) Similarly, when Example 12(a) is repeated using 17% by weight of hydrogen peroxide, 0.2% by weight of saponin and 3% by weight of citric acid, the results are equivalent to those observed in Example 12 (a).

(d) Similarly, when Example 12(a) is performed using a 5% by weight of equivalent hydrogen peroxide as generated in situ by sodium percarbonate, 0.2% by weight of saponin and 2% by weight of citric acid, the results are equivalent to those observed in Example 12 (a).

(e) Similarly, when Example 12(a) is repeated except that hydrogen peroxide is replace by sodium percarbonate equivalent to produce 4% of hydrogen peroxide in situ, 0.4% by weight crude Yucca extract (20% active saponin) and 0.2% by weight of ascorbic acid, the results are equivalent to those observed in Example 12 (a).

While only a few embodiments of the invention have been shown and described herein, it will be apparent to those skilled in the art that various modifications and changes can be made in the pesticide formulation and its components and its methods of use without departing from the spirit and scope of the present invention. All such modifications and changes coming within the scope of the appended claims are intended to be carried out thereby.

We claim:

1. A pesticide composition for controlling stench, algae, moss, slime, mold, fungus, insects, insect larvae, pathological organisms, anaerobic conditions and combinations thereof in water bodies, on plants, in soil, on surfaces and combinations thereof, said composition comprising: an oxidizing component selected from the group consisting of hydrogen peroxide, a hydrogen peroxide-generating chemical compound, an inorganic hydroperoxide, an organic peroxy acid and combinations thereof and a saponin glycoside.

2. The composition of claim 1 which further comprises one or more organic carboxylic acids that act as pH buffers, modifiers and chemical stabilizers for the mixture.

3. The composition of claim 1 wherein the hydrogen peroxide generating compound is selected from the groups consisting of sodium percarbonate, sodium peroxide, sodium perborate, sodium persulfate, calcium peroxide, magnesium peroxide and combinations thereof.

4. The composition of claim 1 wherein the hydrogen peroxide, or the hydrogen peroxide by the hydrogen peroxide generator, is in water in a concentration range of about 1 to 50% by weight of hydrogen peroxide or generator equivalent to hydrogen peroxide.

5. The composition of claim 1 wherein the saponin chemical compounds is in water in a concentration range of about 0.001 to 25% by weight.

6. The composition of claim 1 wherein one or more organic carboxylic acids are in water in a concentration range of about 0.001 to 25% by weight.

7. The method for algae removal and control, which method comprises applying to said algae an effective amount of the composition of claim 1.

8. The method of claim 1 for control and eradication of insect pests or their larvae, and combinations thereof, which method comprises contact of said insect pests, their larvae, and combinations thereof with an effective amount a composition itself comprising hydrogen peroxide or a hydrogen peroxide-generating compound and a saponin glycoside.

9. The method for the control and eradication of harmful pathogens in water bodies, which method comprises: contacting said harmful pathogens with an effective amount of the composition of claim 1.

10. The method for the control and eradication of harmful pathogens on surfaces, which method comprises: contacting with an effective amount of the pesticide composition of claim 1.

11. The method for the control and eradication of harmful pathogens on and within turf grass, which method comprises: contacting said turf grass with an effective amount of the pesticide composition of claim 1.

12. The method for odor removal or control in water bodies, on surfaces, and on and within turf grass, which method comprises: contacting said bodies, surfaces, or turf grass with an effective amount of the pesticide composition of claim 1.

13. The method for control and eradication of insect pests, algae control, and for the control and eradication of pathogens in water bodies and on surfaces, and for odor removal or control, which method comprises: contacting the insect pests, algae, or pathogens with an effective amount of the composition of claim 2.

14. The method for control of insect pests, algae, and moss on and within turf grass, which method comprises: surface contacting with an effective amount of the composition of claim 2.

15. The method for control and destruction of sulfurous layers found in soils, which method comprises: contacting, within the soil and combinations thereof with an effective amount of the composition of claim 2.

16. The method for control and eradication of insect pests and algae control, which method comprises: surface contacting with an effective amount of the composition of claim 2.

17. The method for the selective treatment of water body features, which are ornamental, functional, and combinations thereof, selected from the group consisting of rock, bridge, island, fountain, waterfall, pump, filtering, skimmer, drain, and combinations thereof, which method comprises: direct spraying or stream applying to said features of an effective composition of claim 1.

18. The method of claim 17, which further comprises: a pH pretreatment such that the hydrogen peroxide remains active and is not rapidly decomposed.

19. The method of claim 17 wherein the composition is applied to a drained water feature, followed by refilling of the water feature and scum removal by the water action and skimming.

20. The method of claim 17 wherein the composition is applied to water features by direct spray or stream application to said features by manual or automatic methods.

21. The method of claim 17 wherein the composition is applied to water features by aerial spray or stream application.

22. The method of claim 17 wherein the composition is applied to turf by direct spray or stream application to said features by manual or automatic methods.

23. The method of claim 17 wherein the composition is applied to turf by injection into the turf manually or by machine.

24. The method of algae and detritus, which method further comprises: removal by selectively applying the composition of claim 1 to water body features, and skimming by manual or automated means the buoyant detritus formed by the application of the composition.

25. The method of claim 17, which method comprises: applying the oxidative composition to a water feature, and observing no harm to nearby desirable flora or fauna.

26. The method of claim 17, which method further comprises:
applying the oxidative compound to a water feature without removal of desirable flora or fauna prior to, during, or after treatment.

27. An aqueous pesticide composition for controlling stench, algae, moss, slime, mold, fungus, insects, insect larvae, pathological organisms, anaerobic conditions and combinations thereof in water bodies, on plants, in soil, on surfaces, and combinations thereof, said composition comprising: an oxidizing component selected from the group consisting of hydrogen peroxide, a hydrogen peroxide-generating chemical compound, an inorganic hydroperoxide, an organic peroxy acid and combinations thereof in a concentration of between about 1 and 50% by weight of hydrogen peroxide or hydrogen peroxide equivalent, and a saponin glycoside in a concentration of between about 0.001 and 25% by weight.

28. A method for controlling stench, algae, moss, slime, mold, fungus, insects, insect larvae, pathological organisms, anaerobic conditions and combinations thereof in water bodies, on plants, in soil, on surfaces, and combinations thereof, said composition comprising: contacting said algae, moss, slime, mold, fungus, insects, insect larvae, pathological organisms, anaerobic conditions and combinations thereof in water bodies, on plants, in soil, on surfaces, and combinations thereof with an aqueous pesticide composition itself comprising: an oxidizing component selected from the group consisting of hydrogen peroxide, a hydrogen peroxide-generating chemical compound, an inorganic hydroperoxide, an organic peroxy acid and combinations thereof in a concentration of between about 1 and 50% by weight of hydrogen peroxide or hydrogen peroxide equivalent, and a saponin glycoside in a concentration of between about 0.001 and 25% by weight.
